(19) United States
(12) Patent Application Publication
(10) Pub. No.: US 2012/0111997 A1
(43) Pub. Date: May 10, 2012

(54) ROTORCRAFT EMPENNAGE

(75) Inventor: Robert Owen White, Orillia (CA)

(73) Assignee: GROEN BROTHERS AVIATION, INC, Salt Lake City, UT (US)

(21) Appl. No.: 13/349,201

(22) Filed: Jan. 12, 2012

Related U.S. Application Data
(63) Continuation-in-part of application No. 13/199,671, filed on Sep. 7, 2011.
Application No. 13/199,671 is a continuation-in-part of application No. 13/199,684, filed on Sep. 7, 2011.
Application No. 13/199,684 is a continuation-in-part of application No. 13/199,678, filed on Sep. 7, 2011.
Application No. 13/199,678 is a continuation-in-part of application No. 13/199,682, filed on Sep. 7, 2011.
Application No. 13/199,682 is a continuation-in-part of application No. 13/199,681, filed on Sep. 7, 2011.
Application No. 13/199,681 is a continuation-in-part of application No. 13/199,677, filed on Sep. 7, 2011.
Application No. 13/199,677 is a continuation-in-part of application No. 13/199,679, filed on Sep. 7, 2011.
Application No. 13/199,679 is a continuation-in-part of application No. 13/199,720, filed on Sep. 7, 2011.
Application No. 13/199,720 is a continuation-in-part of application No. 13/373,439, filed on Nov. 14, 2011.
Application No. 13/373,439 is a continuation-in-part of application No. 13/199,719, filed on Sep. 7, 2011.
Application No. 13/199,719 is a continuation-in-part of application No. 13/199,721, filed on Sep. 7, 2011.
Application No. 13/199,721 is a continuation-in-part of application No. 13/199,705, filed on Sep. 7, 2011.
Application No. 13/199,705 is a continuation-in-part of application No. 13/282,749, filed on Oct. 27, 2011.
Application No. 13/282,749 is a continuation-in-part of application No. 13/199,712, filed on Sep. 7, 2011.
Application No. 13/199,712 is a continuation-in-part of application No. 13/282,780, filed on Oct. 27, 2011.
Application No. 13/282,780 is a continuation-in-part of application No. 13/282,815, filed on Oct. 27, 2011.
Application No. 13/282,815 is a continuation-in-part of application No. 13/282,877, filed on Oct. 27, 2011.
Application No. 13/282,877 is a continuation-in-part of application No. 13/282,938, filed on Oct. 27, 2011.
Application No. 13/282,938 is a continuation-in-part of application No. 13/373,406, filed on Nov. 14, 2011.
Application No. 13/373,406 is a continuation-in-part of application No. 13/283,461, filed on Oct. 27, 2011.
Application No. 13/283,461 is a continuation-in-part of application No. 13/282,985, filed on Oct. 27, 2011.
Application No. 13/282,985 is a continuation-in-part of application No. 13/317,749, filed on Oct. 27, 2011.
Application No. 13/317,749 is a continuation-in-part of application No. 13/317,750, filed on Oct. 27, 2011.
Application No. 13/317,750 is a continuation-in-part of application No. 13/317,751, filed on Oct. 27, 2011.
Application No. 13/317,751 is a continuation-in-part of application No. 13/373,421, filed on Nov. 14, 2011.
Application No. 13/373,421 is a continuation-in-part of application No. 13/373,433, filed on Nov. 14, 2011.
Application No. 13/373,433 is a continuation-in-part of application No. 13/373,413, filed on Nov. 14, 2011.
Application No. 13/373,413 is a continuation-in-part of application No. 13/373,440, filed on Nov. 14, 2011.
Application No. 13/373,440 is a continuation-in-part of application No. 13/334,261, filed on Dec. 22, 2011.
Application No. 13/334,261 is a continuation-in-part of application No. 13/335,541, filed on Dec. 22, 2011.
Application No. 13/335,541 is a continuation-in-part of application No. 13/373,414, filed on Nov. 14, 2011.
Application No. 13/373,414 is a continuation-in-part of application No. 13/373,412, filed on Nov. 14, 2011.
Application No. 13/373,412 is a continuation-in-part of application No. 13/373,420, filed on Nov. 14, 2011.
(60) Provisional application No. 61/432,488, filed on Jan. 13, 2011.
(60) Provisional application No. 61/381,291, filed on Sep. 9, 2010.
(60) Provisional application No. 61/403,099, filed on Sep. 9, 2010.
(60) Provisional application No. 61/403,097, filed on Sep. 9, 2010.
(60) Provisional application No. 61/381,313, filed on Sep. 9, 2010.
(60) Provisional application No. 61/403,111, filed on Sep. 9, 2010.
(60) Provisional application No. 61/381,347, filed on Sep. 9, 2010.
(60) Provisional application No. 61/403,136, filed on Sep. 9, 2010.
(60) Provisional application No. 61/403,134, filed on Sep. 9, 2010.
(60) Provisional application No. 61/460,572, filed on Jan. 3, 2011.
(60) Provisional application No. 61/403,098, filed on Sep. 9, 2010.
(60) Provisional application No. 61/403,081, filed on Sep. 9, 2010.
(60) Provisional application No. 61/403,135, filed on Sep. 9, 2010.
(60) Provisional application No. 61/466,177, filed on Mar. 22, 2011.
(60) Provisional application No. 61/409,475, filed on Nov. 2, 2010.
(60) Provisional application No. 61/403,113, filed on Sep. 9, 2010.
(60) Provisional application No. 61/409,478, filed on Nov. 2, 2010.
(60) Provisional application No. 61/409,476, filed on Nov. 2, 2010.
(60) Provisional application No. 61/409,482, filed on Nov. 2, 2010.
(60) Provisional application No. 61/409,470, filed on Nov. 2, 2010.
(60) Provisional application No. 61/517,413, filed on Apr. 19, 2011.
(60) Provisional application No. 61/468,964, filed on Mar. 29, 2011.
(60) Provisional application No. 61/409,487, filed on Nov. 2, 2010.
(60) Provisional application No. 61/409,494, filed on Nov. 2, 2010.
(60) Provisional application No. 61/456,219, filed on Nov. 2, 2010.
(60) Provisional application No. 61/456,221, filed on Nov. 2, 2010.
(60) Provisional application No. 61/456,220, filed on Nov. 2, 2010.
(60) Provisional application No. 61/506,572, filed on Jul. 11, 2011.
(60) Provisional application No. 61/519,075, filed on May 16, 2011.
(60) Provisional application No. 61/519,055, filed on May 16, 2011.
(60) Provisional application No. 61/460,573, filed on Jan. 4, 2011.
(60) Provisional application No. 61/461,223, filed on Jan. 13, 2011.
(60) Provisional application No. 61/429,282, filed on Jan. 3, 2011.
(60) Provisional application No. 61/429,289, filed on Jan. 3, 2011.
(60) Provisional application No. 61/575,196, filed on Aug. 17, 2011.
(60) Provisional application No. 61/499,996, filed on Jun. 22, 2011.
(60) Provisional application No. 61/575,204, filed on Aug. 18, 2011.
(60) Provisional application No. 61/532,233, filed on Sep. 8, 2011.
(60) Provisional application No. 61/539,668, filed on Sep. 27, 2011.
(60) Provisional application No. 61/626,783, filed on Oct. 3, 2011.

(51) Int. Cl. B64C 9/00; B64C 27/02

(52) U.S. Cl. 244/87

(57) ABSTRACT

An aircraft is disclosed having an engine and a propeller mounted to a fuselage. An empennage mounts to the aircraft and includes first and second horizontal stabilizers separated by a distance greater than the diameter of a stream tube of the propeller at the horizontal stabilizers. A rudder extends between the horizontal stabilizers and is positioned within the stream tube of the propeller. The rudder may mount to a first vertical stabilizer extending between the horizontal stabilizers. The horizontal stabilizers may be secured to second and third vertical stabilizers to form a duct having the rudder positioned within the duct. Additional rudders may mount to the second and third vertical stabilizers.

### RELATED APPLICATIONS

This application claims the benefit of co-pending U.S. Provisional Patent Application Ser. No. 61/432,488, filed on Jan. 13, 2011, co-pending U.S. Provisional Patent Application Ser. No. 61/466,177, filed on Mar. 22, 2011, co-pending U.S. Provisional Patent Application Ser. No. 61/468,964, filed on Mar. 29, 2011, co-pending U.S. Provisional Patent Application Ser. No. 61/506,572, filed on Jul. 11, 2011, co-pending U.S. Provisional Patent Application Ser. No. 61/499,996, filed on Jun. 22, 2011, co-pending U.S. Provisional Patent Application Ser. No. 61/532,233, filed on Sept. 8, 2011, co-pending U.S. Provisional Patent Application Ser. No. 61/539,668, filed on Sep. 27, 2011; and is a continuation-in-part of co-pending U.S. patent application Ser. No. 13/199,671, filed on Sep. 7, 2011, which claims the benefit of U.S. Provisional Patent Application Ser. No. 61/381,291, filed on Sep. 9, 2010, co-pending U.S. patent application Ser. No. 13/199,684, filed on Sep. 7, 2011, which claims the benefit of U.S. Provisional Patent Application Ser. No. 61/403,099, filed on Sep. 9, 2010, co-pending U.S. patent application Ser. No. 13/199,678, filed on Sep. 7, 2011, which claims the benefit of U.S. Provisional Patent Application Ser. No. 61/403,097, filed on Sep. 9, 2010, co-pending U.S. patent application Ser. No. 13/199,682, filed on Sep. 7, 2011, which claims the benefit of U.S. Provisional Patent Application Ser. No. 61/381,313, filed on Sep. 9, 2010, co-pending U.S. patent application Ser. No. 13/199,681, filed on Sep. 7, 2011, which claims the benefit of U.S. Provisional Patent Application Ser. No. 61/403,111, filed on Sep. 9, 2010, co-pending U.S. patent application Ser. No. 13/199,677, filed on Sep. 7, 2011, which claims the benefit of U.S. Provisional Patent Application Ser. No. 61/381,347, filed on Sep. 9, 2010, co-pending U.S. patent application Ser. No. 13/199,679, filed on Sep. 7, 2011, which claims the benefit of U.S. Provisional Patent Application Ser. No. 61/403,136, filed on Sep. 9, 2010, co-pending U.S. patent application Ser. No. 13/199,720, filed on Sep. 7, 2011, which claims the benefit of U.S. Provisional Patent Application Ser. No. 61/403,134, filed on Sep. 9, 2010, co-pending U.S. patent application Ser. No. 13/373,439, filed on Nov. 14, 2011, which claims the benefit of U.S. Provisional Patent Application Ser. No. 61/460,572, filed on Jan. 3, 2011, co-pending U.S. patent application Ser. No. 13/199,719, filed on Sep. 7, 2011, which claims the benefit of U.S. Provisional Patent Application Ser. No. 61/403,098, filed on Sep. 9, 2010, co-pending U.S. patent application Ser. No. 13/199,721, filed on Sep. 7, 2011, which claims the benefit of U.S. Provisional Patent Application Ser. No. 61/403,081, filed on Sep. 9, 2010, co-pending U.S. patent application Ser. No. 13/199,705, filed on Sep. 7, 2011, which claims the benefit of U.S. Provisional Patent Application Ser. No. 61/403,135, filed on Sep. 9, 2010, co-pending U.S. patent application Ser. No. 13/282,749, filed on Oct. 27, 2011, which claims the benefit of U.S. Provisional Patent Application Ser. No. 61/409,475, filed on Nov. 2, 2010, co-pending U.S. patent application Ser. No. 13/199,712, filed on Sep. 7, 2011, which claims the benefit of U.S. Provisional Patent Application Ser. No. 61/403,113, filed on Sep. 9, 2010, co-pending U.S. patent application Ser. No. 13/282,780, filed on Oct. 27, 2011, which claims the benefit of U.S. Provisional Patent Application Ser. No. 61/409,478, filed on Nov. 2, 2010, co-pending U.S. patent application Ser. No. 13/282,815, filed on Oct. 27, 2011, which claims the benefit of U.S. Provisional Patent Application Ser. No. 61/409,476, filed on Nov. 2, 2010, co-pending U.S. patent application Ser. No. 13/282,877, filed on Oct. 27, 2011, which claims the benefit of U.S. Provisional Patent Application Ser. No. 61/409,482, filed on Nov. 2, 2010, co-pending U.S. patent application Ser. No. 13/282,938, filed on Oct. 27, 2011, which claims the benefit of U.S. Provisional Patent Application Ser. No. 61/409,470, filed on Nov. 2, 2010, co-pending U.S. patent application Ser. No. 13/373,406, filed on Nov. 14, 2011, which claims the benefit of U.S. Provisional Patent Application Ser. No. 61/517,413, filed on Apr. 19, 2011, co-pending U.S. patent application Ser. No. 13/283,461, filed on Oct. 27, 2011, which claims the benefit of U.S. Provisional Patent Application Ser. No. 61/409,487, filed on Nov. 2, 2010, co-pending U.S. patent application Ser. No. 13/282,985, filed on Oct. 27, 2011, which claims the benefit of U.S. Provisional Patent Application Ser. No. 61/409,494, filed on Nov. 2, 2010, co-pending U.S. patent application Ser. No. 13/317,749, filed on Oct. 27, 2011, which claims the benefit of U.S. Provisional Patent Application Ser. No. 61/456,219, filed on Nov. 2, 2010, co-pending U.S. patent application Ser. No. 13/317,750, filed on Oct. 27, 2011, which claims the benefit of U.S. Provisional Patent Application Ser. No. 61/456,221, filed on Nov. 2, 2010, co-pending U.S. Patent Application Ser. No. 13/317,751, filed on Oct. 27, 2011, which claims the benefit of U.S. Provisional Patent Application Ser. No. 61/456,220, filed on Nov. 2, 2010, co-pending U.S. patent application Ser. No. 13/373,421, filed on Nov. 14, 2011, which claims the benefit of U.S. Provisional Patent Application Ser. No. 61/519,075, filed on May 16, 2011, co-pending U.S. patent application Ser. No. 13/373,433, filed on Nov. 14, 2011, which claims the benefit of U.S. Provisional Patent Application Ser. No. 61/519,055, filed on Aug. 22, 2011, co-pending U.S. patent application Ser. No. 13/373,413, filed on Nov. 14, 2011, which claims the benefit of U.S. Provisional Patent Application Ser. No. 61/460,573, filed on Jan. 4, 2011, co-pending U.S. patent application Ser. No. 13/373,440, filed on Nov. 14, 2011, which claims the benefit of U.S. Provisional Patent Application Ser. No. 61/461,223, filed on Jan. 13, 2011, co-pending U.S. patent application Ser. No. 13/334,261, filed on Dec. 22, 2011, which claims the benefit of U.S. Provisional Patent Application Ser. No. 61/429,282, filed on Jan. 3, 2011, co-pending U.S. patent application Ser. No. 13/335,541, filed on Dec. 22, 2011, which claims the benefit of U.S. Provisional Patent Application Ser. No. 61/429,289, filed on Jan. 3, 2011, co-pending U.S. patent application Ser. No. 13/373,414, filed on Nov. 14, 2011, which claims the benefit of U.S. Provisional Patent Application Ser. No. 61/575,196, filed on Aug. 17, 2011, co-pending U.S. patent application Ser. No. 13/373,412, filed on Nov. 14, 2011, which claims the benefit of U.S. Provisional Patent Application Ser. No. 61/575,204, filed on Aug. 17, 2011, and co-pending U.S. patent application Ser. No. 13/373,420, filed on Nov. 14, 2011, which claims the benefit of U.S. Provisional Patent Application Ser. No. 61/626,783, filed on Oct. 3, 2011, all of which are hereby incorporated by reference.

Additionally, this patent application hereby incorporates by reference U.S. Pat. No. 5,301,900 issued Apr. 12, 1994 to Groen et al., U.S. Pat. No. 1,947,901 issued Feb. 20, 1934 to J. De la Cierva, and U.S. Pat. No. 2,352,342 issued Jun. 27, 1944 to H. F. Pitcairn.

### BACKGROUND

1. The Field of the Invention

This invention relates to rotating wing aircraft, and, more particularly to rotating wing aircraft relying on autorotation of a rotor to provide lift.

2. The Background Art

Rotating wing aircraft rely on a rotating wing to provide lift. In contrast, fixed wing aircraft rely on air flow over a fixed wing to provide lift. Fixed wing aircraft must therefore achieve a minimum ground velocity on takeoff before the lift on the wing is sufficient to overcome the weight of the plane. Fixed wing aircraft therefore generally require a long runway along which to accelerate to achieve this minimum velocity and takeoff.

In contrast, rotating wing aircraft can take off and land vertically or along short runways inasmuch as powered rotation of the rotating wing provides the needed lift. This makes rotating wing aircraft particularly useful for landing in urban locations or undeveloped areas without a proper runway.

The most common rotating wing aircraft in use today are helicopters. A helicopter typically includes an airframe, housing an engine and passenger compartment, and a rotor, driven by the engine, to provide lift. Forced rotation of the rotor causes a reactive torque on the airframe. Accordingly, conventional helicopters require either two counter-rotating rotors or a tail rotor in order to counteract this reactive torque.

Another type of rotating wing aircraft is the autogyro. An autogyro aircraft derives lift from an unpowered, freely rotating rotor or plurality of rotary blades. The energy to rotate the rotor results from a windmill-like effect of air passing through the underside of the rotor. The forward movement of the aircraft comes in response to a thrusting engine such as a motor driven propeller mounted fore or aft.

During the developing years of aviation aircraft, autogyro aircraft were proposed to avoid the problem of aircraft stalling in flight and to reduce the need for runways. The relative airspeed of the rotating wing is largely independent of the forward airspeed of the autogyro, allowing slow ground speed for takeoff and landing, and safety in slow-speed flight. Engines may be tractor-mounted on the front of an autogyro or pusher-mounted on the rear of the autogyro.

Airflow passing the rotary wing, alternately called rotor blades, which are tilted upward toward the front of the autogyro, act somewhat like a windmill to provide the driving force to rotate the wing, i.e., autorotation of the rotor. The Bernoulli effect of the airflow moving over the rotor surface creates lift.

Various autogyro devices in the past have provided some means to begin rotation of the rotor prior to takeoff, thus further minimizing the takeoff distance down a runway. One type of autogyro is the “gyrodyne,” which includes a gyrodyne built by Fairey aviation in 1962 and the XV-1 convertiplane first flight tested in 1954. The gyrodyne includes a thrust source providing thrust in a flight direction and a large rotor for providing autorotating lift at cruising speeds. To provide initial rotation of the rotor, jet engines were secured to the tip of each blade of the rotor and powered during takeoff, landing, and hovering.

In many prior autogyros, pitch control is provided by adjusting one or both of the cyclic pitch of the airfoil blades constituting the rotor and the angle of the rotor disc. Pitch stability is facilitated through the use of a single, fixed horizontal stabilizer positioned within the airstream (e.g., stream tube) of a rear-mounted propeller. The horizontal stabilizer acts to keep the aircraft pitch stable in forward flight by balancing forces from the weight of the aircraft and aerodynamic forces acting on the wings, rotor, and airframe.

In some gyroplanes, yaw control is achieved by either a single rudder positioned within the stream tube or a combination of main rudders and auxiliary rudders, where the main rudders are positioned one either side of the stream tube and the auxiliary rudder is positioned within the stream tube. In forward flight, at speeds above 40 knots, yawing of the aircraft is effected by rotating the main rudders. At slower speeds, auxiliary rudders are used to direct the propeller thrust to the starboard or port side of the aircraft, producing a yawing motion.

The following detailed description provides an improved apparatus and method for controlling yaw and providing yaw and pitch stability in a rotorcraft, such as an autogyro.

### BRIEF SUMMARY OF THE INVENTION

The invention has been developed in response to the present state of the art and, in particular, in response to the problems and needs in the art that have not yet been fully solved by currently available apparatus and methods. The features and advantages of the invention will become more fully apparent from the following description and appended claims, or may be learned by practice of the invention as set forth hereinafter.

In one aspect of the invention, an aircraft is disclosed, including an airframe, an engine mounted to the airframe, and a propeller operably coupled to the engine. A boom system is mounted to the airframe and an empennage is mounted to the airframe by means of the boom system. The empennage includes first and second horizontal stabilizers offset from one another by a separation distance larger than a stream tube of the propeller. The separation distance may be less than a diameter of the propeller. A rudder is positioned between the first and second horizontal stabilizers and may be horizontally centered on the first and second horizontal stabilizers. The propeller may be positioned between the airframe and the empennage.

In another aspect of the invention, a first vertical stabilizer extends between the first and second horizontal stabilizers and the rudder is mounted to the first vertical stabilizer.

In another aspect of the invention, second and third vertical stabilizers are secured to the first and second horizontal stabilizers having the first vertical stabilizer positioned therebetween. The boom system may include first and second booms mounted to the airframe and secured to the second and third vertical stabilizers, respectively. The second and third vertical stabilizers may be horizontally separated by a distance greater than the diameter of the propeller.

In another aspect of the invention, the aircraft includes a bulkhead and both the engine and boom system are mounted to the bulkhead. The landing gear may also be mounted to the bulkhead.

In another aspect of the invention, a rotor is mounted to the airframe and the aircraft is an autogyro.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is an isometric view of a rotorcraft in accordance with an embodiment of the present invention;

FIG. 2 is a top plan view of an empennage in accordance with an embodiment of the present invention;

FIG. 3 is a rear elevation view of a rotorcraft incorporating an empennage in accordance with an embodiment of the present invention;

FIG. 4A is a top plan view of a boom structure for supporting an empennage in accordance with an embodiment of the present invention; and

FIG. 4B is a top plan view of an alternative boom structure for supporting an empennage in accordance with an embodiment of the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

This patent application hereby incorporates by reference U.S. Pat. No. 5,301,900 issued Apr. 12, 1994 to Groen et al., U.S. Pat. No. 1,947,901 issued Feb. 20, 1934 to J. De la Cierva, and U.S. Pat. No. 2,352,342 issued Jun. 27, 1944 to H. F. Pitcairn.

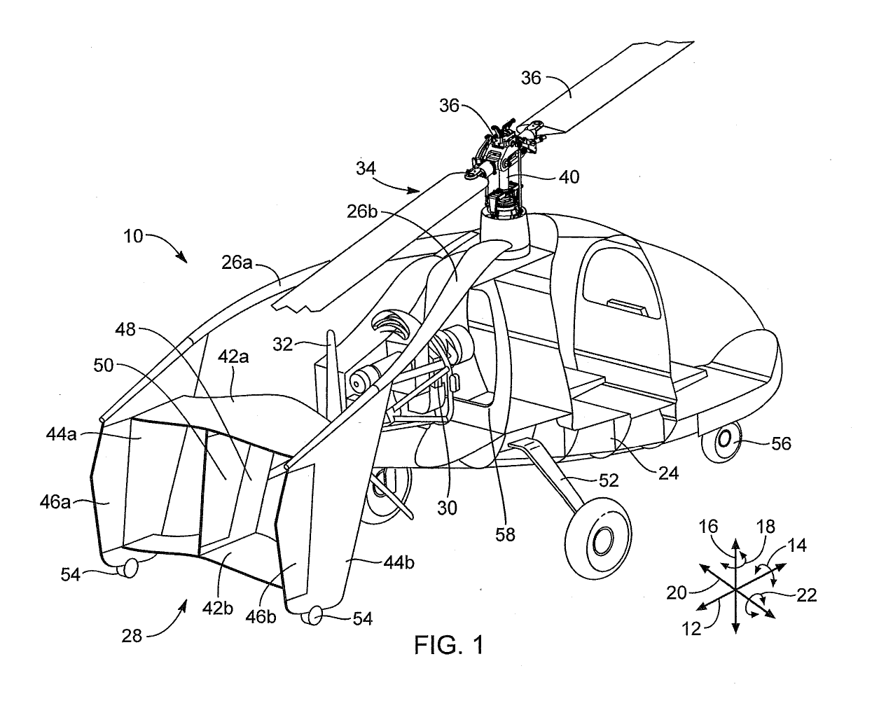

Referring to FIG. 1, an aircraft 10 may define a longitudinal direction 12, which corresponds generally to the direction of flight of the aircraft during sustained translational flight. A roll direction 14 may be defined as a rotation about an axis parallel to the longitudinal direction 12. A vertical direction 16 may be defined as perependicular to the longitudinal axis and generally parallel to the force of gravity during sustained translational flight.

A yaw direction 18 may be defined as rotation about an axis parallel to the vertical direction 16. A lateral direction 20 may be defined as a perpendicular to both the longitudinal direction 12 and the vertical direction 16. A pitch direction 22 may be defined as a rotation about an axis parallel to the lateral direction 20.

The aircraft 10 may include an airframe 24 containing a cockpit and corresponding flight controls, as well as any compartments for passengers, cargo, or both. One or more booms 26a, 26b secure to the airframe 24 and extend rearwardly therefrom. The booms 26a, 26b support an empennage 28 containing control surfaces for maintaining stability in the pitch direction 22 and yaw direction 18 and for controlling motion of the aircraft 10 in the yaw direction 18.

An engine 30 may also be mounted to the airframe 24 and have a propeller 32 operably coupled thereto and driven thereby. In the illustrated embodiment, the propeller 32 projects rearwardly from the airframe 24. The one or more booms 26a, 26b may function to position the empennage 28 such that the propeller 32 is positioned between the airframe 24 and empennage 28. The booms 26a, 26b may also project rearwardly from the propeller 32 sufficiently to provide a minimum separation distance between the propeller 32 and the empennage 28.

A rotor 34 may also mount to the airframe 24 and may be powered or unpowered. The rotor 34 may include two or more rotor blades 36 secured to a hub 38 rotatably mounted to a mast 40. The pitch of the blades 36 may be altered collectively, cyclically, or both as known in the art of rotorcraft design and operation. Likewise, the angle of attack of the rotor disc defined by the blades 36 may also be adjusted, such as by adjusting an angle of the mast 40 or of a head with respect to the mast 40 as known in the art of rotorcraft design and operation.

For aircraft 10 embodied as an autogyro, the rotor 34 may be powered by the engine 30 or some other power source during takeoff or landing and otherwise left unpowered, particularly during sustained longitudinal flight. During sustained longitudinal flight, the aircraft 10 is urged forward by the propeller 32 and rotation of the rotor 34 is due to autorotation as known in the art of autogyro design and operation.

The empennage 28 may include first and second horizontal stabilizers 42a, 42b. The horizontal stabilizers 42a, 42b may secure at their ends to the vertical stabilizers 44a, 44b such that the combined horizontal stabilizers 42a, 42b and vertical stabilizers 44a, 44b define a box or duct structure. Main rudders 46a, 46b may secure to trailing edges of the vertical stabilizers 44a, 44b and be selectively actuated to cause movement of the aircraft 10 in the yaw direction 18. A vertical stabilizer 48 may be positioned between the vertical stabilizers 44a, 44b and have an auxiliary rudder 50 mounted thereto. The illustrated configuration advantageously positions the auxiliary rudder 50 within the box or duct formed by the vertical stabilizers 44a, 44b and the horizontal stabilizers 42a, 42b and may provide improved thrust vectoring of air flow from the propeller 32. The improved thrust vectoring may improve yaw control at low speeds.

The auxiliary rudder 50 may be actuated synchronously with the main rudders 46 or may be decoupled from the main rudders 46a, 46b during high speed flight, e.g., above 40 kts, such that yaw control inputs from a pilot are only coupled to the main rudders 46a, 46b. Yaw control inputs may be coupled to the auxiliary rudder 50 during low speed flight, e.g., below 40 knots, and may or may not be decoupled from the main rudders 46a, 46b.

The operation of the main rudders 46a, 46b and auxiliary rudder 50 may be as described in U.S. Provisional Patent Application Ser. No. 61/409,494, filed Nov. 2, 2010 and entitled “USE OF AUXILIARY RUDDERS FOR YAW CONTROL AT LOW SPEED,” which is hereby incorporated herein by reference in its entirety.

The aircraft 10 may include main landing gear 52 including wheels or skids for engaging the ground during takeoff and landing. Additional landing gear 54, either wheels or skids, may be mounted to the empennage 28 to avoid damage to the empennage 28 during takeoff and landing. In the illustrated embodiment, the landing gear 54 mount to lower surfaces of the vertical stabilizers 44a, 44b. A nose landing gear 56 may also secure to the airframe 24 at the nose of the aircraft 10.

In some embodiments, the airframe 24 may include a bulkhead 58 embodied as a structural member that lies generally in a plane parallel to (and actually co-planar with) both the lateral direction 20 and the vertical direction 16. The bulkhead 58 may be a single monolithic member or may be formed of a number of constituent members. In some embodiments, some or all of the engine 30, booms 26a, 26b, landing gear 52, and mast 40 may mount to the same bulkhead 58. In this manner, the aircraft 10 may be made lighter in weight since a single sturdy member supports each of the major, load- bearing components of the aircraft 10.

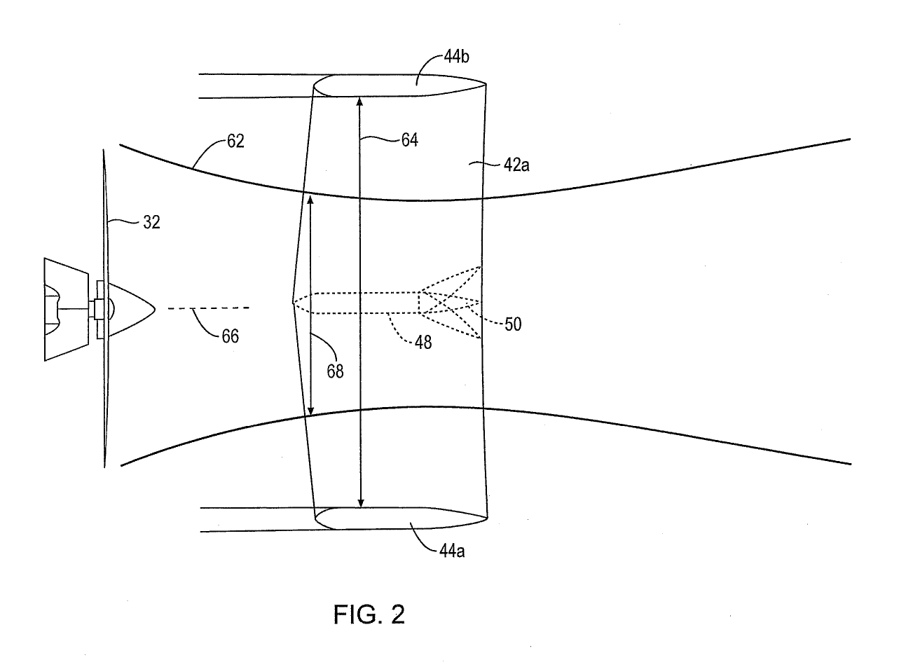

Referring to FIG. 2, during operation, the propeller 32 urges air flow rearwardly and generates a stream tube 62. Due to conservation of mass, acceleration of air by the propeller 32 causes the stream tube to form a vena contracta smaller in diameter than the diameter of the propeller for a region immediately behind the propeller 32. In the illustrated embodiment, the stream tube 62 is directed through the box or duct formed by the horizontal stabilizers 42a, 42b and the vertical stabilizers 44a, 44b.

As noted above, the main rudders 46a, 46b are operable to control yaw of the aircraft at higher speeds. The main rudders 46a, 46b may therefore be positioned in the “free stream” outside of the stream tube 62 of the propeller 32. They may instead be positioned within the slip stream of the aircraft 10 in order to generate forces in the yaw direction 18 through interaction with the slip stream. Accordingly, the main rudders 46a, 46b and the vertical stabilizers 44a, 44b to which they are mounted may be separated by a distance 64.

The location of the vertical stabilizers 44a, 44b relative to the axis of rotation 66 of the propeller 32 may be such that neither of the vertical stabilizers 44a, 44b is located within the stream tube 62. Accordingly, the distance 64 may be greater than the diameter 68 of the stream tube 62 at the leading edge of the vertical stabilizers 44a, 44b or the diameter 68 of the stream tube 62 measured at the leading edge of one of the horizontal stabilizers 42a, 42b. In some embodiments, the distance 64 may be greater than the diameter of the propeller 32 or greater than a width of the airframe 24 in the lateral direction 20.

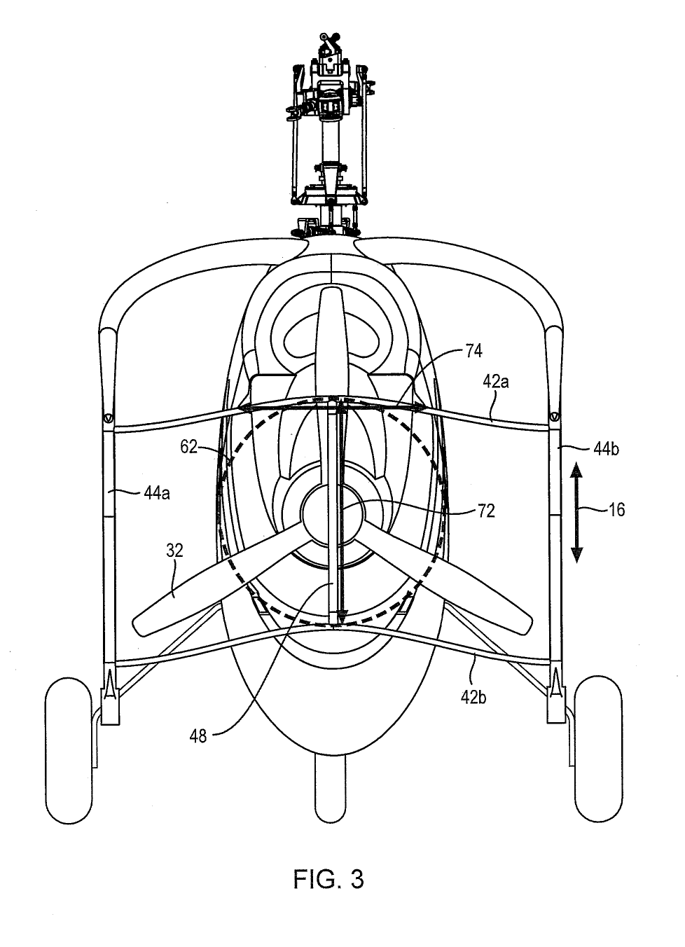

Referring to FIG. 3, the horizontal stabilizers 42a, 42b may also be positioned such that they do not significantly interact with the stream tube 62. This configuration may advantageously reduce interference by the horizontal stabilizers 42a, 42b with the stream tube 62 and increase aerodynamic efficiency of the aircraft 10. Accordingly, the horizontal stabilizers 42a, 42b may be separated by a distance 72 in the vertical direction 16 that is greater than the diameter of the stream tube 62 at the leading edge of either of the horizontal stabilizers 42a, 42b.

As noted above, the stream tube 62 becomes narrower than the diameter of the propeller 32 immediately behind the propeller. Accordingly, the horizontal stabilizers 42a, 42b may have a separation distance 72 less than the diameter of the propeller and still not interact with the stream tube 62. For example, the separation distance 72 may be between 0.6 and 1.2 times the diameter of the propeller 32. Alternatively, the separation distance 72 may be between 0.6 and 1 times the diameter of the propeller 32. Alternatively, the separation distance 72 may be between 0.8 and 1 times the diameter of the propeller 32.

Such a configuration has been found to be used by prior art aircraft. Aircraft are optimized for their functionality. However, controlling parameters for comparatively low speed slight may be inconsistent with the needs of high speed flight. Likewise, rotorcraft rely on different structures and parametric values than fixed wing aircraft. High speed VTOL aircraft must therefore start with a “clean sheet of paper,” so to speak.

In some embodiments, the separation distance 72 and the position of the horizontal stabilizers 42a, 42b may be such that the length 74 of the leading edge of either horizontal stabilizer 42a, 42b located within the stream tube 62 is less than ten percent of that of the horizontal stabilizer 42a, 42b.

As in FIG. 3, the horizontal stabilizers 42a, 42b may slope downwardly from the center thereof. However, in other embodiments, the horizontal stabilizers may slope upward or be straight. Where the separation distance 72 is not constant along the lengths of the horizontal stabilizers 42a, 42b, the separation distance 72 along the horizontal stabilizers 42a, 42b may be such that, for the portions of the horizontal stabilizers 42a, 42b that are horizontally coextensive with the stream tube 62, the separation distance 72 in the vertical direction 16 is always larger than the diameter of the stream tube 62.

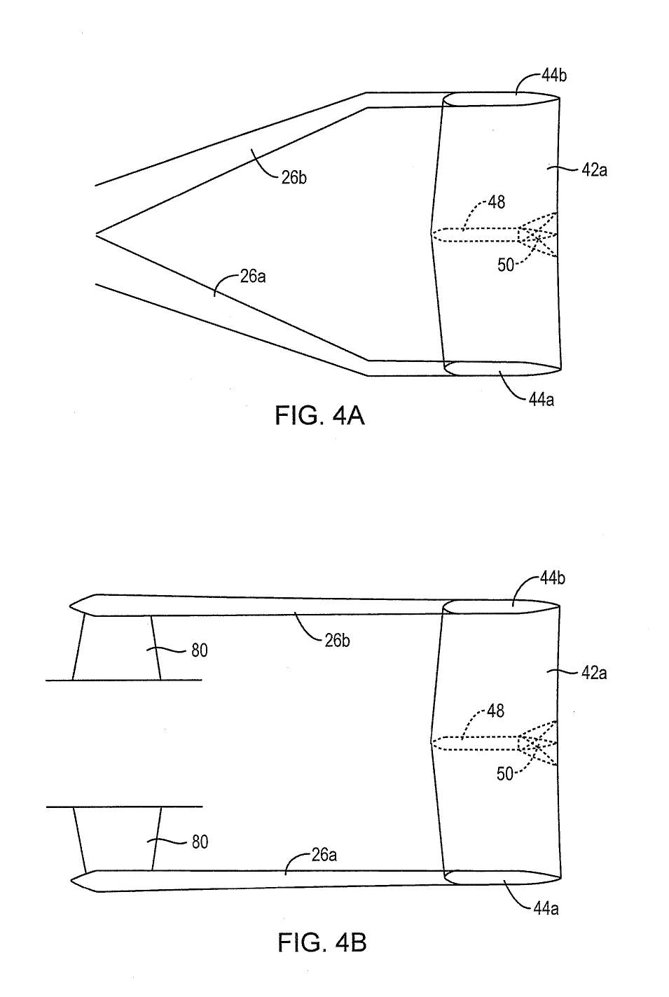

Referring to FIG. 4A, while referring again to FIG. 1, in the illustrated embodiment, the booms 26a, 26b extend from the vertical stabilizers 44a, 44b and mount to the top of the fuselage 24 adjacent the mast 40. Referring to FIG. 4B, in an alternative embodiment, the booms 26a, 26b may mount to the sides of the fuselage 24. For example, wing stubs 80, having an airfoil contour, may project outwardly from the fuselage 24 and secure the booms 26a, 26b. Alternatively, the wing stubs 80 may be replaced by spars that do not have an airfoil contour.

For purposes of this disclosure, the stream tube 62 and the diameter of the stream tube at the leading edge of the horizontal stabilizers 42a, 42b are these values measured at a given air speed. For example, in some embodiments, the air speed at which the stream tube 62 is measured is any velocity within a range of cruising velocities for the aircraft 10, as known in the art of aircraft design. Alternatively, the velocity at which the stream tube 62 is measured is a fixed value, such as 40 knots for an autogyro aircraft.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An aircraft comprising:
an airframe;
an engine mounted to the airframe;
a propeller operably coupled to the engine;
a boom system mounted to the airframe; and
an empennage mounted to the boom system and including
first and second horizontal stabilizers offset from one another by a separation distance equal to between 0.6 and 1 times a diameter of the propeller; and
a rudder positioned between the first and second horizontal stabilizers;
wherein the propeller is positioned between the airframe and the empennage.

2. The aircraft of claim 1, wherein the rudder is substantially horizontally centered on the first and second horizontal stabilizers.

3. The aircraft of claim 2, wherein a first vertical stabilizer extends between the first and second horizontal stabilizers and wherein the rudder is mounted to the first vertical stabilizer.

4. The aircraft of claim 3, further comprising second and third vertical stabilizers, the second and third vertical stabilizers being secured to the first and second horizontal stabilizers having the first vertical stabilizer positioned therebetween.

5. The rotor craft of claim 4, wherein the boom system includes first and second booms secured to the air frame, the first boom secured to the second vertical stabilizer and the second boom secured to the third vertical stabilizer.

6. The aircraft of claim 4, wherein the second and third vertical stabilizers are horizontally separated by a distance greater than the diameter of the propeller.

7. The aircraft of claim 4, wherein the rudder is a first rudder, the aircraft further comprising second and third rudders mounted to the second and third vertical stabilizers.

8. The aircraft of claim 1, wherein:
the aircraft includes a bulkhead and landing gear; and
the engine, boom system, and landing gear are mounted to the bulkhead.

9. The aircraft of claim 1, further comprising a rotor mounted to the airframe.

10. The aircraft of claim 1, wherein the aircraft is an autogyro.

11. An aircraft comprising:
an airframe;
an engine mounted to the airframe;
a propeller operably coupled to the engine;
a boom system mounted to the airframe; and
an empennage mounted to the boom system;
The empennage further comprising first and second horizontal stabilizers offset from one another by a separation distance greater than or equal to a diameter of a stream tube of the propeller measured at an airspeed of 40 knots at a leading edge of at least one of the first and second horizontal stabilizers, the separation distance being less than or equal to a diameter of the propeller; and
a rudder positioned between the first and second horizontal stabilizers;
wherein the propeller is positioned between the airframe and the empennage.

12. The aircraft of claim 11, wherein the rudder is substantially horizontally centered on the first and second horizontal stabilizers.

13. The aircraft of claim 11, wherein:
a first vertical stabilizer extends between the first and second horizontal stabilizers; and
the rudder is mounted to the vertical stabilizer.

14. The aircraft of claim 13, further comprising:
second and third vertical stabilizers;
the second and third vertical stabilizers being secured to the first and second horizontal stabilizers; and
the second and third vertical stabilizers having the first vertical stabilizer positioned therebetween.

15. The aircraft of claim 14, wherein the second and third vertical stabilizers are horizontally separated by a distance greater than the diameter of the propeller.

16. The rotor craft of claim 14, wherein the boom system includes first and second booms secured to the air frame, the first boom secured to the second vertical stabilizer and the second boom secured to the third vertical stabilizer.

17. An autogyro comprising:
an airframe;
a rotor mounted to the airframe and operable in autorotation during powered translational flight;
an engine mounted to the airframe;
a propeller operably coupled to the engine and defining an axis of rotation;
a boom system mounted to the airframe; and
an empennage mounted to the boom system and including
first and second horizontal stabilizers positioned on either side of the axis of rotation and offset from one another by a separation distance such that less than ten percent of the length of either of the first and second horizontal stabilizers is positioned within a stream tube of the propeller at a cruising speed of the aircraft; and
a rudder positioned between the first and second horizontal stabilizers, wherein the propeller is positioned between the airframe and the empennage.

18. The aircraft of claim 17, wherein the rudder is substantially horizontally centered on the first and second horizontal stabilizers.

19. The aircraft of claim 17, further comprising first and second vertical stabilizers, the first and second vertical stabilizers being secured to the first and second horizontal stabilizers, the first rudder being positioned therebetween.

20. The rotor craft of claim 19, wherein the boom system includes first and second booms secured to the air frame, the first boom secured to the second vertical stabilizer and the second boom secured to the third vertical stabilizer.
